(19) United States
(12) Patent Application Publication
(10) Pub. No.: US 2025/0094031 A1
(43) Pub. Date: Mar. 20, 2025

(54) DISPLAY METHOD, DISPLAY APPARATUS, AND ELECTRONIC DEVICE

(71) Applicant: Lenovo (Beijing) Limited, Beijing (CN)

(72) Inventor: Yongliang WANG, Beijing (CN)

(21) Appl. No.: 18/883,895

(22) Filed: Sep. 12, 2024

(30) Foreign Application Priority Data
Sep. 15, 2023 (CN) 202311195771.6

(51) Int. Cl. G06F 3/04845; G06F 3/0481

(52) U.S. Cl. CPC G06F 3/04845; G06F 3/0481; G06F 2203/04804

(57) ABSTRACT

A display method includes: displaying a content output window in an output area of an electronic device; in response to a content input trigger operation, displaying an input window with a first presentation attribute value in the output area, wherein when the input window with the first presentation attribute value is displayed, the content output window has a second presentation attribute value; and in response to an input operation on the input window, displaying a corresponding input content in the content output window.

### CROSS-REFERENCE TO RELATED APPLICATION

This application claims priority to Chinese Patent Application No. 202311195771.6, filed on Sep. 15, 2023, and the entire content of which is incorporated herein by reference.

### TECHNICAL FIELD

The present disclosure relates to the technical field of display technology, and more particularly, to a display method, a display apparatus, and an electronic device.

### BACKGROUND

When using an electronic device, if a display area on a display screen in a current operation mode is too small and input operations need to be performed on the display screen, regardless of using a 9-grid or 26-grid input keyboard, an input touch area is relatively small, and the input content cannot be seen clearly due to the small display area. this reduces input efficiency and affects user input experience.

### SUMMARY

One aspect of the present disclosure provides a display method. The method includes: displaying a content output window in an output area of an electronic device; in response to a content input trigger operation, displaying an input window with a first presentation attribute value in the output area, wherein when the input window with the first presentation attribute value is displayed, the content output window has a second presentation attribute value; and in response to an input operation on the input window, displaying a corresponding input content in the content output window.

Another aspect of the present disclosure provides a display apparatus. The display apparatus includes a memory storing a computer program and a processor configured to execute the computer program to: display a content output window in an output area of an electronic device; in response to a content input trigger operation, display an input window with a first presentation attribute value in the output area, wherein when the input window with the first presentation attribute value is displayed, the content output window has a second presentation attribute value; and in response to an input operation on the input window, display a corresponding input content in the content output window.

Another aspect of the present disclosure provides an electronic device. The electronic device includes a body and a display apparatus. The display apparatus includes a memory storing a computer program and a processor configured to execute the computer program to: display a content output window in an output area of an electronic device; in response to a content input trigger operation, display an input window with a first presentation attribute value in the output area, wherein when the input window with the first presentation attribute value is displayed, the content output window has a second presentation attribute value; and in response to an input operation on the input window, display a corresponding input content in the content output window.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a schematic diagram of a hardware structure of an electronic device performing a display method according to some embodiments of the present disclosure;

FIG. 2 is a flowchart of an exemplary display method according to some embodiments of the present disclosure;

FIG. 3 is a flowchart of another exemplary display method according to some embodiments of the present disclosure;

FIG. 4A is schematic diagram of an application scenario of a display method according to some embodiments of the present disclosure;

FIG. 4B is schematic diagram of another application scenario of a display method according to some embodiments of the present disclosure;

FIG. 4C is schematic diagram of another application scenario of a display method according to some embodiments of the present disclosure;

FIG. 5 is a flowchart of another exemplary display method according to some embodiments of the present disclosure;

FIG. 6 is a flowchart of another exemplary display method according to some embodiments of the present disclosure;

FIG. 7 is a flowchart of another exemplary display method according to some embodiments of the present disclosure;

FIG. 8 is a flowchart of another exemplary display method according to some embodiments of the present disclosure; and

FIG. 9 is a schematic structural diagram of a display apparatus according to some embodiments of the present disclosure.

### DETAILED DESCRIPTION OF THE EMBODIMENTS

In view of the description of the background technology, when an output area (such as a display screen) of an electronic device in a current operation mode is small, a content output window is displayed in the output area, and a content input operation needs to be performed on the same output area. When a content input window is called, the content input window may be controlled to be displayed in the output area in a display state with a first presentation attribute value (such as one or more of a window size, window transparency, etc.). At this time, the content output window may have a second presentation attribute value (such as one or more of window size, window transparency, etc., often the same type as the first presentation attribute value). That is, when performing the content input operation, the presentation attribute values of the content output window and the content input window may be controlled to be different. In this way, the presentation attribute values of the corresponding windows can be flexibly adjusted, which is convenient for a user to perform the content input operation in the content input window, and displayed input content can also be clearly viewed through the content output window, thereby improving a content input efficiency on a small screen, and at the same time, improving user experience of small-screen electronic devices.

The technical scheme in the embodiment of the present application will be clearly and completely described below in conjunction with the drawings in the embodiments of the present disclosure. Obviously, the described embodiment is merely a part of the embodiments of the present disclosure, not all of the embodiments. Based on the embodiments in the present disclosure, all other embodiments obtained by ordinary people in the art without creative work are within the scope of the present disclosure.

Throughout the present disclosure, unless the context clearly indicates an exception, the terms “one”, “a”, “a kind” and/or “the” do not specifically refer to the singular, but may also include the plural. Generally, the terms “include” and “comprise” only indicate the inclusion of clearly identified steps and elements, and these steps and elements do not constitute an exclusive list, and the method or device may also include other steps or elements. The elements defined by the sentence “include one . . . ” do not exclude the existence of other identical elements in the process, method, commodity or device including the elements.

In the description of the embodiments of the present disclosure, unless otherwise specified, “/” means or, for example, A/B can mean A or B; “and/or” in this specification is only a kind of association relationship describing the associated objects, indicating that there can be three relationships, for example, A and/or B can mean: A exists alone, A and B exist at the same time, and B exists alone.

The following terms “first” and “second” are used for descriptive purposes only and should not be understood as indicating or implying relative importance or implicitly indicating the number of technical features indicated. Thus, a feature defined as “first” or “second” may explicitly or implicitly include one or more of the features. Unless otherwise specified, in the description of the embodiments of the present disclosure, “plurality” means two or more than two.

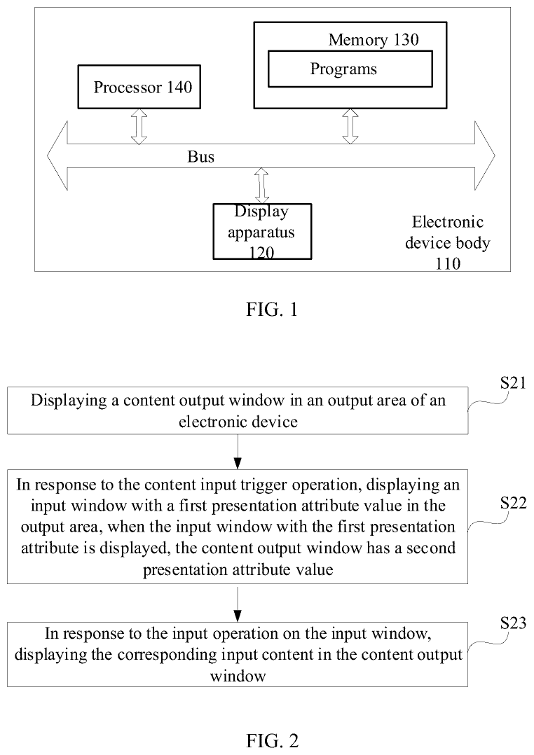

FIG. 1 is a schematic diagram of a hardware structure of an electronic device performing a display method according to some embodiments of the present disclosure. The electronic device may be a smart phone (such as a folding phone), a smart watch, or an electronic device with a small screen, or an electronic device with multiple application windows in an output area, which makes viewing and operation inconvenient. As shown in FIG. 1, the electronic device may include a body 110, at least one display apparatus 120, at least one memory 130, and at least one processor 140 disposed in the body 110. The body 110 may have a structure determined according to types and functions thereof, and may include elements that perform basic functions of the electronic device, such as a housing, a main board, various sensors deployed on the main board, a microphone, a speaker, a vibration component, and a touch sensing unit for sensing touch events on a touch display panel, etc., which are not limited by the present disclosure.

The display apparatus 120, the memory 130, and the processor 140 may be connected with each other through a bus or other communication methods to transfer data among them. The present disclosure takes a connection method shown in FIG. 1 as an example for description. The bus may include an address bus, a data bus, and a control bus, etc., which are not shown separately in FIG. 1, may be determined according to actual needs, and are not elaborated in detail in the present disclosure.

The display apparatus 120 may include a touch display panel, i.e., a touch display screen, etc. For different types of electronic devices, display screens of the same or different sizes may be disposed on different surfaces of the electronic device, for example, a display screen of a folding electronic device may also be a curved screen, a folding screen, etc., such that the electronic device can be in different operation modes (such as a folded mode or a flattened mode) and can use corresponding display screens disposed on different surfaces. The number of display apparatuses 120 of different types on the electronic devices and disposed positions thereof, operation modes, etc. are not limited by the present disclosure and may be determined as needed.

The memory 130 may be used to store a program for implementing a display method provided by the present disclosure, for example, inputting content, and to store logic codes for implementing basic functions of the electronic device as needed. The processor 140 may load and execute the program stored in the memory 130 to implement various processes of the display method provided by the present disclosure. Specific implementation processes may refer to the description of the corresponding embodiments below, and will not be described in detail herein.

In the embodiments of the present disclosure, the memory 130 may include a high-speed random-access memory (RAM). The memory 130 may also include a non-volatile memory, such as at least a disk storage device, for example, a hard disk drive (HDD) or a solid-state drive (SSD), or other volatile solid-state storage devices, such as random-access memory (RAM). Of course, to implement the display method provided by the present disclosure, the memory 130 may also be any other medium that carries or stores the program and can be accessed by a computer, or may be a circuit or any other devices that can perform a storage function. The present disclosure does not limit types of the memory 130 contained in the electronic device and any working content thereof, which may be determined according to actual circumstances.

The processor 140 may be a central processing unit (CPU), an application-specific integrated circuit (ASIC), a digital signal processor (DSP), an off-the-shelf programmable gate array (FPGA) or other programmable logic devices, discrete gates or transistor logic devices, discrete hardware components or other general-purpose processors such as microprocessors, etc., and may implement or execute the methods, processes, and logic block diagrams disclosed in the embodiments of the present disclosure. It should be understood that in the implementation process, the processes of the following method embodiments may be directly executed by the hardware processor 140, or may be implemented by a combination of hardware and software modules in the processor 140, depending on the actual circumstances.

It should be understood that the structure of the electronic device shown in FIG. 1 does not constitute a limitation on the electronic device in the embodiments of the present disclosure. In actual applications, the electronic device may include more or fewer components than those shown in FIG. 1, or combine certain components, which are not explicitly described in the present disclosure.

FIG. 2 is a flowchart of an exemplary display method according to some embodiments of the present disclosure. The display method may be applied to the electronic device described above. As shown in FIG. 2, the display method may include but is not limited to the following processes.

At S21, a content output window is displayed in an output area of an electronic device.

In a current operation mode of the electronic device, the output area (such as a screen) that can be used is small in size, such as a foldable mobile phone in a folded state using a screen on a folding surface, and the display area is small in size. A user directly operates on the output area to display a content output window, such as an output window of any application in the electronic device, for example, a short message input/output window or a document output window, etc. The present disclosure does not limit the type of the content output window.

The content output window may be displayed flatly in the output area to facilitate a clearer and faster viewing of the displayed content in the limited output area, or to allow the user to perform a content input trigger operation thereon. Of course, a display mode of the content output window in the output area of the electronic device is not limited to the flat display mode, and may be determined in combination with information such as the operation mode of the electronic device.

At S22, in response to the content input trigger operation, an input window (or a content input window) with a first presentation attribute value is displayed in the output area. When the input window with the first presentation attribute is displayed, the content output window may have a second presentation attribute value.

Based on the above analysis, when a content input operation is required on the content output window, the content input trigger operation may be performed. For example, a touch operation is performed on a content display area of the content output window (for example, clicking on the screen, inputting at least one of a preset track/graphic, etc.), a touch operation is performed on an input identifier displayed in the content output window, an input function button of the electronic device is pressed. The content input trigger operation may be determined based on configuration parameters of an input touch operation. The operation mode is not limited by the present disclosure.

After the user performs the content input trigger operation, the electronic device may respond to the content input trigger operation and may output the input window for the user to perform an input operation (or a content input operation), such as an input keyboard panel. At this time, to facilitate the user to perform the input operation on the to-be-output input window and clearly see a to-be-input content, when the input window is launched, a preset presentation attribute thereof is controlled to be the first presentation attribute value, such that the input window with the first presentation attribute value is displayed in the output area of the electronic device. At the same time, the preset presentation attribute of the content output window may be controlled to be the second presentation attribute value. The present disclosure does not limit an implementation method of controlling the window presentation attribute value.

The first presentation attribute value may not be a default presentation attribute value of the input window. In particular, for the electronic device with the foldable screen such as the foldable mobile phone, when the input window is displayed on a larger screen in a flattened state, the input window may have the default presentation attribute value, and when the input window is displayed on a small screen in a folded state, the input window has the first presentation attribute value. However, for electronic devices of a certain form such as smart watches, the first presentation attribute value may also be the default attribute value.

Similarly, the second presentation attribute value may be the default presentation attribute value of the corresponding presentation attribute of the content output window, or may be another presentation attribute value pre-configured to facilitate the user to perform the input operation in the input window and see the input content clearly in the content output window. The present disclosure does not limit the values of the first presentation attribute value and the second presentation attribute value, and a presentation attribute category (such as at least one of window size or display transparency), which may be determined according to the actual circumstances.

At S23, in response to the input operation on the input window, the corresponding input content is displayed in the content output window.

Because the currently displayed input window has the first presentation attribute value, for example, a larger window size, or a lower display transparency than the content output window, it is convenient for the user to perform the content input operation in the input window, for example, touch input operations on input keys on the input keyboard panel, or handwriting content input operations, etc. A corresponding sensor of the electronic device may synchronously detect the input operation, obtain the corresponding input content by responding to the input operation, and synchronously display the input content in the content output window. The present disclosure does not limit the implementation method of how to perform the content input operation in the input window.

It can be seen that when the output area of the electronic device needs to display the content output window and the input window at the same time, the present disclosure improves the convenience of the user's input operation in the input window by controlling the preset presentation attributes of the two windows to have different presentation attribute values, thereby improving the content input efficiency, such that the user has a more comfortable input experience.

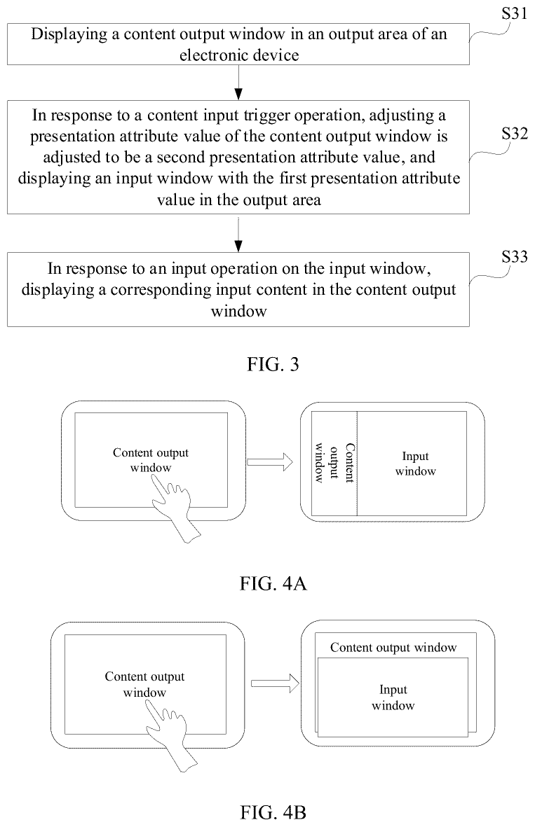

FIG. 3 is a flowchart of another exemplary display method according to some embodiments of the present disclosure. As shown in FIG. 3, the method may include the following processes.

At S31, a content output window is displayed in an output area of an electronic device.

At S32, in response to a content input trigger operation, a presentation attribute value of the content output window is adjusted to be a second presentation attribute value, and an input window with the first presentation attribute value is displayed in the output area.

At S33, in response to an input operation on the input window, a corresponding input content is displayed in the content output window.

In the embodiments of the present disclosure, to facilitate input operations by displaying the input window in the limited output area, in response to a content input touch operation process, while controlling the input window to have the first presentation attribute value, the current presentation attribute value of the content output window may be adjusted to the second presentation attribute value at the same time. The present disclosure does not limit the implementation method of adjusting the presentation attributes of each window.

In the case where the output area of the electronic device needs to display the content output window and the input window at the same time, a user experience of the content input operation may be improved by adjusting the presentation attribute values of the content output window and the input window, for example, the display size. Therefore, during the execution of S32, the display size of the content output window may be reduced, and at the same time, the input window with the larger display size may be controlled to be displayed in the output area, such that the display size of the content output window is smaller than the display size of the input window. That is, in some embodiments, the first presentation attribute value is greater than the second presentation attribute value. The specific values can be determined according to the display size of the output area. The present disclosure does not limit the adjustment of the display size of each window.

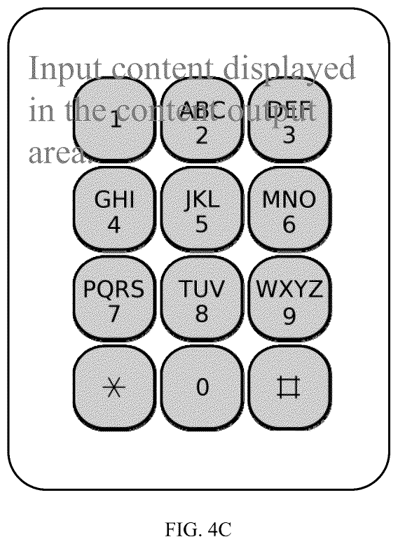

As described above, when the content output window and the input window are displayed in different areas of the output area, which refers to two non-overlapping display areas, during the display size adjustment or configuration process of the two windows, it is ensured that a sum of the second presentation attribute value of the adjusted content output window, i.e., a second display size, and the first presentation attribute value of the input window, i.e., a first display size, is smaller than or equal to the display size of the output area of the electronic device, thereby ensuring that the contents of the two windows are displayed entirely, as shown in FIG. 4A.

In some embodiments, when the display areas of the two windows do not overlap, after adjusting the display sizes of the two windows according to the above method, the user may choose to display a partial window in the output area, for example, displaying the area where the content is located in the content output window, displaying the entire input window or the current operation area therein, etc. At this time, the sum of the first display size and the second display size will be greater than the display size of the output area. The present disclosure does not limit the relationships among the display sizes of the content output window, the input window, and the output area. To facilitate the input operation, the first display size is greater than the second display size, but the exact values of the two are not limited by the present disclosure.

In some embodiments, the content output window and the input window may be displayed in different parts of the output area, for example, in two partially overlapping display areas, as shown in FIG. 4B. In this case, the input window may have a larger first display size. During the input operation on the input window, the input window may block a part of the content output window, and a blank area of the content output window may be overlapped to display the input window to avoid blocking any existing input content. However, the present disclosure is not limited to this overlapping display relationship.

In some embodiments, as described previously, the display size of the content output window may be synchronously reduced according to the above method, as shown in FIG. 4A, or the current display size of the content output window may remain unchanged, and the current presentation attribute value of the content output window may also remain unchanged, as shown in FIG. 4B. It can be seen that in response to the content input trigger operation, the input window with the adjusted first presentation attribute value may also be directly displayed in the output area, and the current presentation attribute value of the content output window displayed in the output area remains unchanged. In addition, during the process of executing S32, the present disclosure may also adjust one or more of display states including an input content display mode (such as scrolling display, voice playback, etc.), a display size (such as display font size), and a display layout (such as column display, etc.) in the content output window. The present disclosure does not limit how to adjust the content output window, and the content output window may be adjusted differently in different scenarios described in the context. The implementation process is not described in detail via examples in the present disclosure.

In some other embodiments, when the presentation attribute value is the display transparency, the content output window and input window may be displayed simultaneously in different display layers of the output area, such that the two windows can share the output area. For example, both windows may be tiled and displayed in the output area. Because the two windows are located in different display layers and have different display transparency (the greater the display transparency, the higher the content display transparency, that is, the more transparent the content display effect is), as shown in FIG. 4C, while improving the user experience of the content input operation on the input window, the user will not be affected to view the input content displayed in the content output area.

It should be noted that during the input operation, a first display transparency of the input window is smaller than a second display transparency of the content output window, as shown in FIG. 4C. Before the input window enters an editing state, it may be necessary to read the input content displayed in the content output window. At this time, the first display transparency of the input window may be controlled to be greater than the second display transparency of the content output window, for example, the first display transparency may be adjusted to 50%, or even 100%, such that the input window enters a hidden state, or the input window is closed, etc.

In addition, the presentation attributes of the windows include but are not limited to the display size and the display transparency as described above. The presentation attribute values of one or more presentation attributes of the windows may also be adjusted, and an adjustment content and an adjustment method may be selected according to the actual situation. In some embodiments, in the scenario shown in FIG. 4B, that is, when there is a partial overlapping area between the input window and the content output window, the display transparency of the overlapping area may be adjusted, especially when the display content appears in the overlapping area of the content output window, the display transparency thereof may be increased, and all display contents may be viewed without affecting the content input operation of the input window.

In the embodiments of the present disclosure, when the output area needs to

display the content output window and the input window at the same time, the presentation attribute values of the two windows may be adjusted in time according to actual needs, which makes it convenient for the user to perform the input operations on the input window. In some scenarios, the user is ensured to clearly read the input content displayed in the content output window at the same time, thereby improving input efficiency and reliability.

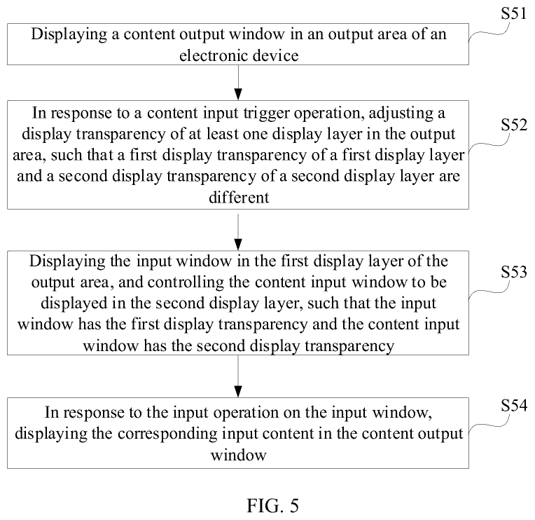

FIG. 5 is a flowchart of another exemplary display method according to some embodiments of the present disclosure. As shown in FIG. 5, the method may include the following processes.

At S51, a content output window is displayed in an output area of an electronic device.

At S52, in response to a content input trigger operation, a display transparency of at least one display layer in the output area is adjusted, such that a first display transparency of a first display layer and a second display transparency of a second display layer are different.

In some embodiments, it is expected that while improving the user experience of the content input operation of the input window, the input content displayed in the content output window may also be clearly read. The two windows may share the output area, and the input window and the content output window may be displayed at their maximum sizes. Therefore, the present disclosure may adjust the display transparency of the display layer corresponding to the output area of the electronic device for displaying the two windows. However, the display transparency values of the two display layers respectively are not limited by the present disclosure, which may be determined according to actual needs. The present disclosure will not describe in detail the implementation method of adjusting the display transparency values of the display layers.

At S53, the input window is displayed in the first display layer of the output area, and the content input window is controlled to be displayed in the second display layer, such that the input window has the first display transparency and the content input window has the second display transparency.

If the display layers of the output area are the first display layer, the second display layer, etc. from top to bottom, the input operation performed on the output area may be performed by the window displayed in the first display layer, that is, the input operation performed on the window of the first display layer. In this way, at S51, the content output window is displayed in the first display layer, and the display transparency of the first display layer is the default value, such as 0, that is, normal display, and the displayed content is not transparent.

According to the method described above, the input window is launched, and the input window needs to be used for the content input operation. When the input window is in the editing state, the input window may be controlled to be displayed in the first display layer, and the content output window may be controlled to be adjusted from the first display layer to the second display layer for display, such that the input window located in the first display layer has the first display transparency, and the content output window located in the second display layer has the second display transparency. Because the first display transparency of the first display layer is smaller than the second display transparency of the second display layer, the display transparency currently possessed by the input window is smaller than the display transparency currently possessed by the content output window, as shown in FIG. 4C, such that the user can more accurately see the content in the input window, and can also distinguish the content in the content output window. Moreover, because the input window may be displayed in the entire output area, the window display size is as large as possible, which makes it more convenient for the user to perform the input operations in the input window, and improves the convenience and efficiency of the input operations.

It should be noted that the display transparency of the first layer and the second layer is not limited to the above relationship, and the first display transparency may also be greater than the second display transparency. The display effect of the content output window and the input window displayed simultaneously in the output area is opposite to what is shown in FIG. 4C. It can be seen that the present disclosure distinguishes the two windows by controlling the different display transparency to accurately identify the window content on the first display layer, and also not affect the viewing of the window content in the second display layer. The present disclosure does not limit exact values of the two display transparency, which may be flexibly configured according to actual needs.

At S54, in response to the input operation on the input window, the corresponding input content is displayed in the content output window.

As described above for the corresponding part of S21, for different types of input windows and their current input methods, appropriate input operations may be used to perform the content input, and the obtained input content may be controlled to be displayed in the content output window. The implementation process is not described in detail in the present disclosure.

It can be seen that when the size of the output area of the electronic device is relatively small in the current operation mode, after the content output window is displayed, the input window needs to be launched to perform the content input operation. The present disclosure provides that the two windows share the entire output area for display, that is, the content output window and the input window completely overlap and are both displayed flatly in the output area. At the same time, to distinguish the two windows and facilitate the input operations, the display transparency of the display layers where the two windows are located is controlled to be different. In this way, it is convenient for the user to perform the input operations on the input window without affecting the viewing of the input content in the content output window. Incorrect input contents may be discovered in time, which improves the input efficiency and reliability, while also improving input convenience and enhancing the user experience of the input operation.

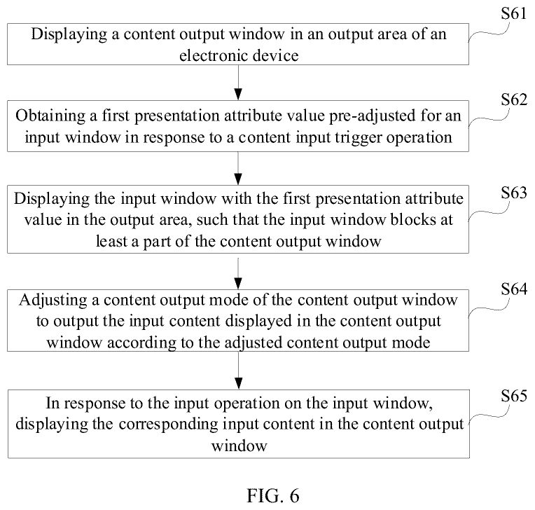

FIG. 6 is a flowchart of another exemplary display method according to some embodiments of the present disclosure. The implementation method of displaying the input window with the first presentation attribute value adjusted specifically in the output area will be described. As shown in FIG. 6, the method may include the following processes.

At S61, a content output window is displayed in an output area of an electronic device.

At S62, a first presentation attribute value pre-adjusted for an input window is obtained in response to a content input trigger operation.

In some embodiments, when the input window is activated, it is expected that the displayed input window has the required first presentation attribute value, such as the first display transparency or the first display size described above, such that the first presentation attribute value of the activated input window can be pre-configured in this scenario. For example, the default presentation attribute value is pre-adjusted to the first presentation attribute value, and the adjustment implementation process is not described in detail. When responding to the content input trigger operation, the first presentation attribute value of the adjusted input window may be directly obtained.

At S63, the input window with the first presentation attribute value is displayed in the output area, such that the input window blocks at least a part of the content output window.

Referring to the display scenario shown in FIG. 4B, for the output area with the smaller display size, to improve the input convenience and efficiency and enhance the user experience of the input operation, the input window may be controlled to be displayed as large as possible, thereby increasing the display size of the input operation area in the input window. As such, the display size of the first presentation attribute value is close to the display size of the output area, and the remaining area of the output area may display the content in the content output window.

In some embodiments, the input window may be controlled to be displayed flatly in the output area, blocking the entire content output window. To distinguish the contents of the two windows, the display transparency of the two windows may be adjusted at the same time according to the method described in the above embodiments. That is, the first presentation attribute value may include the display size and the display transparency, and the implementation process is not described in detail in the present disclosure.

At S64, a content output mode of the content output window is adjusted to output the input content displayed in the content output window according to the adjusted content output mode.

At S65, in response to the input operation on the input window, the corresponding input content is displayed in the content output window.

When a part of the content output window is blocked by the input window, as shown in FIG. 4B, the input content displayed in the content output window may be controlled to be displayed in an unblocked area. To facilitate the viewing of all the input contents, the appropriate content output mode may be adjusted to display the input content, such as scrolling display, switching to voice playback of the input content, etc. The present disclosure does not limit the content output mode of the content output window.

In the embodiments of the present disclosure, when the output area needs to display the content output window and the input window at the same time, the output area is controlled to display the input window with the pre-adjusted first presentation attribute value, such that it blocks at least a part of the content output window. As such, the display size of the input window is as large as possible, and the convenience of the input operation performed on the input window is improved. And by adjusting the content output mode of the content output window, it is ensured that the user can clearly view the input content displayed in the window, and the reliability of content input is improved.

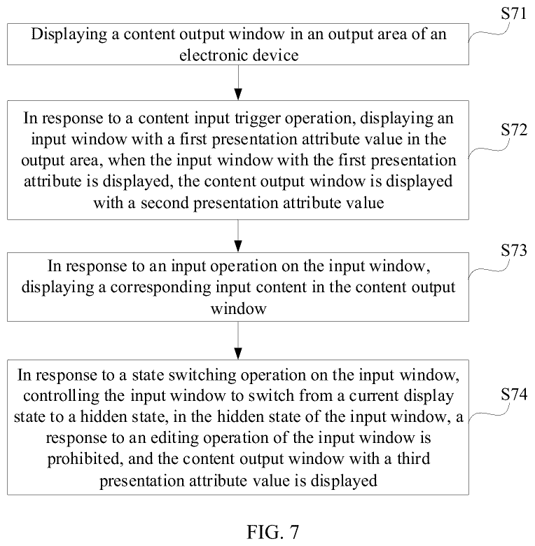

FIG. 7 is a flowchart of another exemplary display method according to some embodiments of the present disclosure. In this case, a display state of the input window can be flexibly adjusted according to different requirements of input and content viewing. As shown in FIG. 7, the method may include the following processes:

At S71, a content output window is displayed in an output area of an electronic device.

At S72, in response to a content input trigger operation, an input window with a first presentation attribute value is displayed in the output area. When the input window with the first presentation attribute is displayed, the content output window is displayed with a second presentation attribute value.

At S73, in response to an input operation on the input window, a corresponding input content is displayed in the content output window.

Regarding the implementation process of processes S71-S73, reference can be made to the description of the above embodiments, and detail description thereof will be omitted herein.

At S74, in response to a state switching operation on the input window, the input window is controlled to switch from a current display state to a hidden state. In the hidden state of the input window, a response to an editing operation of the input window is prohibited, and the content output window with a third presentation attribute value is displayed.

According to the method described above, after the content input operation is completed in the input window, to clearly and comprehensively view the input content, the input window may be controlled to switch to a hidden state, and the content output window may be controlled to have the third presentation attribute value, for example, the content output window is displayed flatly in the output area. If the display transparency changes, the display transparency may be decreased, and may even be 0, that is, opaque, etc. The present disclosure does not limit the third presentation attribute value.

It should be noted that the third presentation attribute value and the second presentation attribute value may be the default attribute value of the content output window. For example, the display size of the second presentation attribute value is the display size of the output area, and the activated input window blocks the display of a part of the content output window. After the input window is controlled to switch to the hidden state, the presentation attribute value of the content output window remains unchanged. Of course, if the display transparency of the content output window is increased when the input window is displayed before, the display transparency of the content output window may be restored to the default value when the input window is switched to the hidden state.

In some embodiments, the switching control of the display state of the input window is described as the input window control process from the display state to the hidden state. The input window is configured with an exit mark or option or exit button and other functions, which can be directly triggered. The electronic device may respond to an exit trigger operation of the input window and control the output area not to display the input window. It can be seen that the hidden state of the input window here can refer to the window closed state.

For the content of the exit trigger operation, one or more preset operations such as gestures, graphics, user postures of using electronic devices, and the posture of the electronic device itself that represent the exit of the input window may also be pre-configured. In this way, a preset operation instruction for indicating the exit of the input window can be detected, and the preset operation instruction is responded to, and the output area is controlled not to display the input window. The present disclosure does not limit the implementation method of the exit trigger operation of the input window, which may be flexibly configured according to actual needs.

In another implementation method of switching the hidden state of the input window, the electronic device may also respond to a trigger operation of inquiring the input content displayed in the content output window to control the output area not to display the input window, but only display the content output window. As such, in the scenario shown in FIG. 4A, a touch operation may be performed on the content output window displayed in the output area, such as clicking the display area of the content output window, etc., to inform the user of the electronic device that the content output window needs to be used and no more content input operation will be performed. The input window may be directly hidden, and the content output window may be controlled to be displayed flatly in the output area, such that the user can clearly view the input content and other displayed content. In the scenario shown in FIG. 4B, the input window may be directly controlled to be hidden, and the display state of the content output window does not need to be adjusted.

In another implementation method of switching the hidden state of the input window, when the first display transparency of the first display layer where the input window is located is smaller than the second display transparency of the second display layer where the content output window is located, and the first display layer is located above the second display layer, as shown in the scenario of FIG. 4C, the input window may also be controlled to be displayed on the second display layer and the content output window to be displayed on the first display layer in response to a layer adjustment operation on the input window panel, such that the content output window can respond to subsequent input operations.

The layer adjustment operation may be performed by pressing a corresponding function key in the electronic device, or performing a preset operation that can achieve layer adjustment, such as the gestures, graphics, etc. described above. The present disclosure does not limit the method for performing the layer adjustment operation for window switching. It should be understood that after completing the review of the content displayed in the content output window, when it is necessary to input content, the input window may still be opened or the input window may be controlled to switch to the display state according to the method described above, and the input operation may continue to be performed in the input window.

In the embodiments of the present disclosure, when the content input operation is required, the output area may be controlled to display the input window, and the input window and the content output window may be controlled to have different presentation attribute values, to conveniently and accurately complete the content input operation on the input window. Afterwards, when it is necessary to review the displayed content in the content output window, the input window may be controlled to switch to the hidden state first, and the content output window may be controlled to have the third presentation attribute value to ensure that the subsequent input operation performed to read the displayed content can be responded by the content output window to avoid any erroneous operation.

In combination with the display method described in the above embodiments, after the output area is controlled to display the input window with the first presentation attribute value, if the display state of the input window is not satisfactory, the first presentation attribute value may also be re-adjusted, such as triggering a setting button or an entry mark for adjusting the presentation attribute of the input window, outputting a corresponding configuration sub-window, and performing a presentation attribute adjustment operation on the configuration sub-window. The present disclosure does not limit the implementation method of adjusting the presentation attribute. As such, after the user performs the adjustment operation, the electronic device may respond to the presentation attribute adjustment operation on the input window and adjust the fourth presentation attribute value of the input window, such as increasing the display size of the input window, or reducing the display transparency, etc. The present disclosure does not limit the fourth presentation attribute value.

Similarly, the present disclosure also adjusts the presentation attribute value of the content output window to facilitate the content input operation. Therefore, the electronic device may also respond to the presentation attribute adjustment operation on the content output window (for the generation method, reference can be made to the operation method described previously) and adjust the content output window to have a fifth presentation attribute value, such as reducing the display size of the content output window, and/or increasing the display transparency, etc. The present disclosure may also adjust the presentation attributes of both the input window and the content output window according to the method described above to improve the convenience and efficiency of the content input operation.

In addition, after the input window is controlled to switch to the hidden state, the presentation attribute of the content output window may also be adjusted according to the method described previously, to facilitate the review of all displayed contents of the content output window. The implementation process is not described in detail herein.

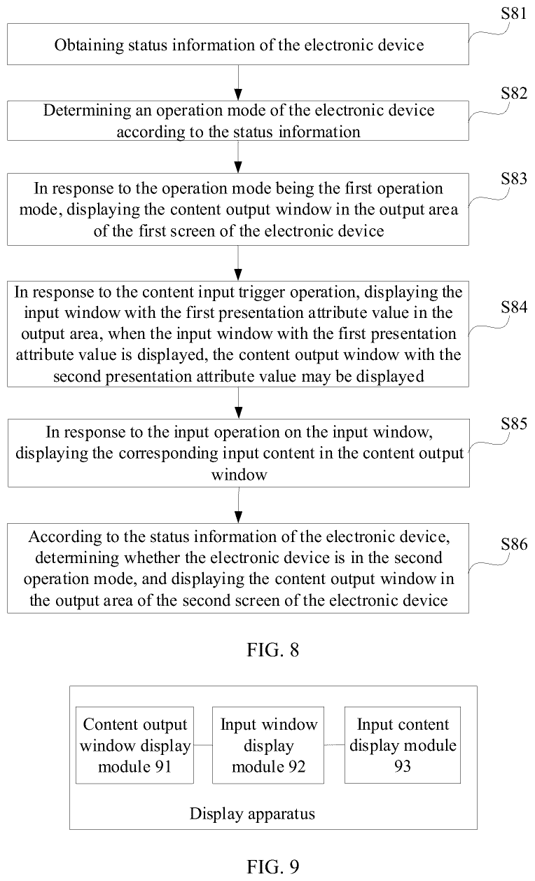

FIG. 8 is a flowchart of another exemplary display method according to some embodiments of the present disclosure. The electronic device to which it is applicable has multiple operation modes, such as folding mobile phones, etc., and different operation modes may have different display controls on the input window and the content output window. As shown in FIG. 8, the method may include the following processes.

At S81, status information of the electronic device is obtained.

In some embodiments, the status information of the electronic device may be

obtained through a status detection device such as a gyroscope, a position sensor, a gravity sensor, or a posture sensor of the electronic device, and the status information may represent whether the electronic device is deformed or the posture changes. The operation modes of the electronic device under different postures are different, especially for folding electronic devices, and the present disclosure does not limit the method for obtaining the status information.

At S82, an operation mode of the electronic device is determined according to the status information.

The operation mode of the electronic device includes a first operation mode and a second operation mode. In the first operation mode (such as a folded state of the electronic device, a folding angle of the electronic device may be determined to be smaller than a preset angle threshold according to the status information, the electronic device may be determined to be in the first operation mode), a first screen of the electronic device enters an operational state. In the second operation mode (such as a flattened state of the electronic device, the folding angle of the electronic device is greater than the preset angle threshold, and the electronic device may be determined to be in the second operation mode), a second screen of the electronic device enters the operational state, and the output area of the first screen is smaller than the output area of the second screen.

In some embodiments, the first screen and the second screen may be different display apparatuses of the electronic device. Of course, the first screen may also be a screen in which the second screen becomes one of two screens after the electronic device is deformed. The present disclosure does not limit the relationship between the first screen and the second screen, which may be determined according to the type of the electronic device.

At S83, in response to the operation mode being the first operation mode, the content output window is displayed in the output area of the first screen of the electronic device.

In some embodiments, in different operation modes, the output area in the operational state of the electronic device is different, and a display mode of the content output window in the output area may also be different, which can be flexibly configured according to the actual situation, and will not be described in detail herein.

At S84, in response to the content input trigger operation, the input window with the first presentation attribute value is displayed in the output area. When the input window with the first presentation attribute value is displayed, the content output window with the second presentation attribute value may be displayed.

At S85, in response to the input operation on the input window, the corresponding input content is displayed in the content output window.

When the electronic device is in the first operation mode, after the input window is activated, the display of the input window and the content output window can be controlled by referring to the method described in the previous embodiments, and the implementation process will not be described in detail herein.

In some embodiments, after the electronic device in the first operation mode activates the input window, the input mode thereof may be configured as a voice input mode. At this time, the input window may be an input panel corresponding to the voice input mode. In this way, the user may directly use a voice recognition function of the electronic device to implement the content input operation. The implementation process is not described in detail herein.

Moreover, because the display size of the input window of the voice input mode is often smaller than the display size of the input window of a keyboard input mode, in the voice input solution, it is not necessary to increase the display size of the input window, and the input window and the content output window are controlled not to overlap. Even for the convenience of viewing the displayed content, the display size of the input window may be smaller than the display size of the content output window, which will not affect the content input operation.

At S86, according to the status information of the electronic device, whether the electronic device is in the second operation mode is determined, and the content output window is displayed in the output area of the second screen of the electronic device.

The two operation modes of the electronic device may be switched between each other. When the electronic device switches to the second operation mode, the content output window may be displayed in the output area of the second screen with a large size. At this time, the content input operation is performed thereon, and the input window is activated. The input window and the content output window may have the default presentation attribute value, which will not affect the content input efficiency and reliability, and can also meet the content viewing requirements.

FIG. 9 is a schematic structural diagram of a display apparatus according to some embodiments of the present disclosure. As shown in FIG. 9, the display apparatus may include a content output window display module 91, an input window display module 92, and an input content display module 93. The content output window display module 91 is used to display a content output window in an output area of an electronic device. The input window display module 92 is used to display an input window with a first presentation attribute value in the output area in response to a content input trigger operation. When the input window with the first presentation attribute is displayed, the content output window may have a second presentation attribute value. The input content display module 93 is used to display corresponding input content in the content output window in response to an input operation on the input window.

In some embodiments, the input window display module 92 may include a first display unit for displaying the input window with the first presentation attribute value adjusted in the output area in response to the content input trigger operation, or a second display unit for adjusting a presentation attribute value of the content output window to the second presentation attribute value in response to the content input trigger operation, and displaying the input window with the first presentation attribute value in the output area.

The content output window and the input window are displayed in different parts of the output area, or the content output window and the input window are simultaneously displayed in different display layers of the output area.

In some other embodiments, the input window display module 92 may also include: a first adjustment unit for adjusting the display transparency of at least one display layer in the output area in response to the content input trigger operation, such that the first content display transparency of the first display layer and the second display transparency of the second display layer are different, and a third display unit for displaying the input window in the first display layer of the output area, and controlling the input window to be displayed in the second display layer, such that the input window has the first display transparency and the content output window has the second display transparency.

In some embodiments, the first display unit may include a first acquisition unit for obtaining the first presentation attribute value pre-adjusted for the input window in response to the content input trigger operation; a fourth display unit for displaying the input window having the first presentation attribute value in the output area, such that the input window covers at least a part of the content output window; and a second adjustment unit for adjusting the content output mode of the content output window to output the input content displayed in the content output window according to the adjusted content output mode.

Based on the display apparatus described in the previous embodiments, the device may further include: a state control module for controlling the input window to switch from the current display state to the hidden state in response to the state switching operation on the input window.

In the hidden state of the input window, it is prohibited to respond to the editing operation of the input window, and the content output window may have the third presentation attribute value.

In some embodiments, the state control module may include any of the following control units: a first control unit for controlling the output area not to display the input window in response to an exit trigger operation on the input window; a second control unit for controlling the output area not to display the input window in response to a trigger operation of querying the input content displayed in the content output window; and a third control unit for controlling the input window to be displayed on the second display layer and the content output window to be displayed on the first display layer in response to the layer adjustment operation on the input window panel when the first display transparency of the first display layer where the input window is located is smaller than the second display transparency of the second display layer where the content output window is located, and the first display layer is located above the second display layer.

In some other embodiments, the display apparatus may also include: a first adjustment module for adjusting the fourth presentation attribute value of the input window in response to the presentation attribute adjustment operation on the input window; and/or, a second adjustment module for adjusting the content output window to have the fifth presentation attribute value in response to the presentation attribute adjustment operation on the content output window.

In some embodiments, the display apparatus may further include: a status information acquisition module for obtaining status information of the electronic device, and an operation mode determination module for determining the operation mode of the electronic device based on the status information. The operation mode includes a first operation mode and a second operation mode, in which the first screen of the electronic device enters an operational state, and in which the second screen of the electronic device enters an operational state, and the output area of the first screen is smaller than the output area of the second screen;

The output area in the operational state of the electronic device is different in different operation modes.

As such, the content output window display module 91 may further include: a fifth display unit for displaying the content output window in the output area of the first screen of the electronic device when the electronic device is in the first operation mode.

It should be noted that the various modules, units, etc. in the device embodiments may be stored in the memory as program modules, and the processor executes the program modules stored in the memory to implement the corresponding functions. The functions implemented by each program module and the combination thereof, as well as the technical effects achieved, may be referred to the description of the corresponding part of the method embodiments, which will not be repeated herein.

The present disclosure also provides a computer-readable storage medium on which a computer program can be stored, which can be called and loaded by a processor to implement the various processes of the display method described in the previous embodiments. For the specific implementation process, reference can be made to the description of the corresponding part of the previous embodiments.

It should be noted that the various embodiments in this specification are described in a progressive or parallel manner, and each embodiment focuses on the differences from other embodiments. The same and similar parts between the various embodiments can refer to each other. For the device and electronic device disclosed in the embodiments, because they correspond to the methods disclosed in the method embodiments, the description thereof is relatively simple, and the relevant parts can refer to the method embodiment description.

The above description of the disclosed embodiments enables professional and technical personnel in the art to implement or use the present disclosure. Various modifications to these embodiments will be obvious to professional and technical personnel in the art, and the general principles defined in this specification can be implemented in other embodiments without departing from the spirit or scope of the present disclosure. Therefore, the present disclosure will not be limited to the embodiments shown in this specification, but will comply with the broadest range consistent with the principles and novel features disclosed in this specification.

What is claimed is:

1. A display method, comprising:
displaying a content output window in an output area of an electronic device;
in response to a content input trigger operation, displaying an input window with a first presentation attribute value in the output area, wherein when the input window with the first presentation attribute value is displayed, the content output window has a second presentation attribute value; and
in response to an input operation on the input window, displaying a corresponding input content in the content output window.

2. The method according to claim 1, wherein displaying the input window with the first presentation attribute value in the output area in response to the content input trigger operation comprises:
in response to the content input trigger operation, displaying the input window with a specifically adjusted first presentation attribute value in the output area; or
in response to the content input trigger operation, adjusting a presentation attribute value of the content output window to be the second presentation attribute value, and displaying the input window with the first presentation attribute value in the output area;
wherein the content output window and the input window are displayed in different parts of the output area, or the content output window and the input window are simultaneously displayed in different display layers of the output area.

3. The method according to claim 1, wherein displaying the corresponding input content in the content output window in response to the input operation on the input window comprises:
in response to then input operation on the input window, adjusting a display transparency of at least one of the display layers of the output area, such that a first display transparency of a first display layer is different from a second display transparency of a second display layer; and
displaying the input window in the first display layer of the output area, and controlling the content output window to be displayed in the second display layer of the output area, such that the input window has the first display transparency, and the content output window has the second display transparency.

4. The method according to claim 2, wherein displaying the input window with the specifically adjusted first presentation attribute value in the output area in response to the content input trigger operation comprises:
in response to the content input trigger operation, obtaining the first presentation attribute value pre-adjusted for the input window;
displaying the input window with the pre-adjusted first presentation attribute value in the output area; and
adjusting a content output mode of the content output window to output the input content displayed in the content output window according to the adjusted content output mode.

5. The method according to claim 1, further comprising:
in response to a state switching operation on the input window, controlling the input window to switch from a current display state to a hidden state, wherein in the hidden state of the input window, a response to an editing operation of the input window is prohibited, and the content output window has a third presentation attribute value.

6. The method according to claim 5, wherein controlling the input window to switch from the current display state to the hidden state in response to the state switching operation on the input window comprises:
in response to an exit trigger operation on the input window, controlling the output area not to display the input window;
in response to a trigger operation of inquiring the input content displayed in the content output window, controlling the output area not to display the input window; and
when a first display transparency of a first display layer where the input window is located is smaller than a second display transparency of a second display layer where the content output window is located, and the first display layer is located above the second display layer, in response to a layer adjustment operation on an input window panel, controlling the input window to be displayed in the second display layer, and the content output window to be displayed in the first display layer.

7. The method according to claim 1, further comprising:
in response to a presentation attribute adjustment operation on the input window, adjusting the presentation attribute value of the input window to a fourth presentation attribute value; and/or
in response to a presentation attribute adjustment operation on the content output window, adjusting the presentation attribute value of the content output window to a fifth presentation attribute value.

8. The method according to claim 1, further comprising:
obtaining status information of the electronic device; and
determining an operation mode of the electronic device according to the status information;
wherein:
the operation mode includes a first operation mode and a second operation mode;
in the first operation mode, a first screen of the electronic device enters an operational state;
in the second operation mode, a second screen of the electronic device enters an operational state, and the output area of the first screen is smaller than the output area of the second screen;
under different operation modes, the output area in the operational state of the electronic device is different; and
displaying the content output window in the output area of the electronic device includes: in response to the electronic device being in the first operation mode, displaying the content output window in the output area of the first screen of the electronic device.

9. A display apparatus, comprising a memory storing a computer program and a processor configured to execute the computer program to:
display a content output window in an output area of an electronic device;
in response to a content input trigger operation, display an input window with a first presentation attribute value in the output area, wherein when the input window with the first presentation attribute value is displayed, the content output window has a second presentation attribute value; and
in response to an input operation on the input window, display a corresponding input content in the content output window.

10. The apparatus according to claim 9, wherein when displaying the input window with the first presentation attribute value in the output area in response to the content input trigger operation, the processor is further configured to:
in response to the content input trigger operation, display the input window with a specifically adjusted first presentation attribute value in the output area; or
in response to the content input trigger operation, adjust a presentation attribute value of the content output window to be the second presentation attribute value, and display the input window with the first presentation attribute value in the output area;
wherein the content output window and the input window are displayed in different parts of the output area, or the content output window and the input window are simultaneously displayed in different display layers of the output area.

11. The apparatus according to claim 9, wherein when displaying the corresponding input content in the content output window in response to the input operation on the input window, the processor is further configured to:
in response to then input operation on the input window, adjust a display transparency of at least one of the display layers of the output area, such that a first display transparency of a first display layer is different from a second display transparency of a second display layer; and
display the input window in the first display layer of the output area, and control the content output window to be displayed in the second display layer of the output area, such that the input window has the first display transparency, and the content output window has the second display transparency.

12. The apparatus according to claim 10, wherein when displaying the input window with the specifically adjusted first presentation attribute value in the output area in response to the content input trigger operation, the processor is further configured to:
in response to the content input trigger operation, obtain the first presentation attribute value pre-adjusted for the input window;
display the input window with the pre-adjusted first presentation attribute value in the output area; and
adjust a content output mode of the content output window to output the input content displayed in the content output window according to the adjusted content output mode.

13. The apparatus according to claim 9, wherein the processor is further configured to:
in response to a state switching operation on the input window, control the input window to switch from a current display state to a hidden state, wherein in the hidden state of the input window, a response to an editing operation of the input window is prohibited, and the content output window has a third presentation attribute value.

14. The apparatus according to claim 13, wherein when controlling the input window to switch from the current display state to the hidden state in response to the state switching operation on the input window, the processor is further configured to:
in response to an exit trigger operation on the input window, control the output area not to display the input window;
in response to a trigger operation of inquiring the input content displayed in the content output window, control the output area not to display the input window; and
when a first display transparency of a first display layer where the input window is located is smaller than a second display transparency of a second display layer where the content output window is located, and the first display layer is located above the second display layer, in response to a layer adjustment operation on an input window panel, control the input window to be displayed in the second display layer, and the content output window to be displayed in the first display layer.

15. The apparatus according to claim 9, wherein the processor is further configured to:
in response to a presentation attribute adjustment operation on the input window, adjust the presentation attribute value of the input window to a fourth presentation attribute value; and/or
in response to a presentation attribute adjustment operation on the content output window, adjust the presentation attribute value of the content output window to a fifth presentation attribute value.

16. The apparatus according to claim 9, wherein the processor is further configured to:
obtain status information of the electronic device; and
determine an operation mode of the electronic device according to the status information;
wherein:
the operation mode includes a first operation mode and a second operation mode;
in the first operation mode, a first screen of the electronic device enters an operational state;
in the second operation mode, a second screen of the electronic device enters an operational state, and the output area of the first screen is smaller than the output area of the second screen;
under different operation modes, the output area in the operational state of the electronic device is different; and
displaying the content output window in the output area of the electronic device includes: in response to the electronic device being in the first operation mode, displaying the content output window in the output area of the first screen of the electronic device.

17. An electronic device, comprising a body and a display apparatus, wherein the display apparatus includes a memory storing a computer program and a processor configured to execute the computer program to:
display a content output window in an output area of an electronic device;
in response to a content input trigger operation, display an input window with a first presentation attribute value in the output area, wherein when the input window with the first presentation attribute value is displayed, the content output window has a second presentation attribute value; and
in response to an input operation on the input window, display a corresponding input content in the content output window.

18. The electronic device according to claim 17, wherein when displaying the input window with the first presentation attribute value in the output area in response to the content input trigger operation, the processor is further configured to:
in response to the content input trigger operation, display the input window with a specifically adjusted first presentation attribute value in the output area; or
in response to the content input trigger operation, adjust a presentation attribute value of the content output window to be the second presentation attribute value, and display the input window with the first presentation attribute value in the output area;
wherein the content output window and the input window are displayed in different parts of the output area, or the content output window and the input window are simultaneously displayed in different display layers of the output area.

19. The electronic device according to claim 17, wherein when displaying the corresponding input content in the content output window in response to the input operation on the input window, the processor is further configured to:
in response to then input operation on the input window, adjust a display transparency of at least one of the display layers of the output area, such that a first display transparency of a first display layer is different from a second display transparency of a second display layer; and
display the input window in the first display layer of the output area, and control the content output window to be displayed in the second display layer of the output area, such that the input window has the first display transparency, and the content output window has the second display transparency.

20. The electronic device according to claim 18, wherein when displaying the input window with the specifically adjusted first presentation attribute value in the output area in response to the content input trigger operation, the processor is further configured to:
in response to the content input trigger operation, obtain the first presentation attribute value pre-adjusted for the input window;
display the input window with the pre-adjusted first presentation attribute value in the output area; and
adjust a content output mode of the content output window to output the input content displayed in the content output window according to the adjusted content output mode.
